(19) United States
(12) Patent Application Publication
(10) Pub. No.: US 2001/0050980 A1
(43) Pub. Date: Dec. 13, 2001

(54) Optical means for cellular phones

(76) Inventor: Hsu-Pang Wang, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/870,667

(22) Filed: Jun. 1, 2001

(30) Foreign Application Priority Data
Jun. 12, 2000 (CN) 00236188.4

(51) Int. Cl. H04B 1/00; H04M 1/00; H04M 9/00

(52) U.S. Cl. 379/110.01; 379/433.04

(57) ABSTRACT

An optical device for electronic products includes at least one transparent plate which has a convex surface on a first side of the at least one transparent plate and a flat surface on the other side of the at least one transparent plate. The flat side of the at least one transparent plate is adhered to the electronic products so as to magnify words, numbers or patterns on the electronic products. The flat side of the at least one transparent plate may also be adhered to a casing having apertures, the electronic product is received in the casing so that the words, numbers or patterns on the electronic products is magnified via the aperture and the transparent plate.

### FIELD OF THE INVENTION

The present invention relates to an optical means for cellular phones is a plate that magnifies number pads and/or screen for convenience of users to identify or see the number pads and/or patterns in the screen clearly.

### BACKGROUND OF THE INVENTION

Modern cellular phones or electronic organizers are so popular that manufacturers are trying to design the cellular phones or electronic organizers to be more compact and have much capacity. However, the small size products reduce every part so that the screen is small and the number pads are small. Therefore, the information illustrated by words or figures is much smaller than those shown in conventional cellular phones or electronic organizer. This will be inconvenient for the users who have optical problems.

The present invention intends to provide an optical means which is convenient to be adhered to the body of the cellular phones or electronic organizer so a to magnify the drawings or words in the screen or the numbers on the number pads.

### SUMMARY OF THE INVENTION

In accordance with one aspect of the present invention, there is provided an optical means for electronic products and comprising at least one transparent plate adhered to the electronic products. The at least one transparent plate has a convex surface and a flat surface which is adhered to the electronic products so as to magnify the words, numbers or patterns on the electronic products.

The primary object of the present invention is to provide an optical plate which magnifies the words, numbers or patterns on the electronic products so that users can see clearly via the optical plate.

Another object of the present invention is to provide an optical plate which is adhered to the electronic products or a casing in which the electronic product is received. By this way, the words, numbers or patterns on the electronic products with compact size are magnified.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show two optical means of the present invention are adhered to a cellular phone;

FIG. 2 is an exploded view to show the two optical means of the present invention and the cellular phone as shown in FIG. 1;

FIG. 3 is a perspective view to show the optical means of the present invention is adhered to a cellular phone casing;

FIG. 4 is a perspective view to show the cellular phone casing with the optical means of the present invention being adhered;

FIG. 5 is a perspective view to show another type of a cellular phone casing with the optical means of the present invention being adhered;

FIG. 6 is a perspective view to show a cellular phone received in the cellular phone casing as shown in FIG. 5;

FIG. 7 is a perspective view to show a cellular phone to which two optical means are adhered;

FIG. 8 is a perspective view to show the optical means of the present invention for use with number pads, and

FIG. 9 is a side cross sectional view to show the optical means of the present invention.

### DETAILED DESCRIPTION OF THE PREFERRED EMBODIMENT

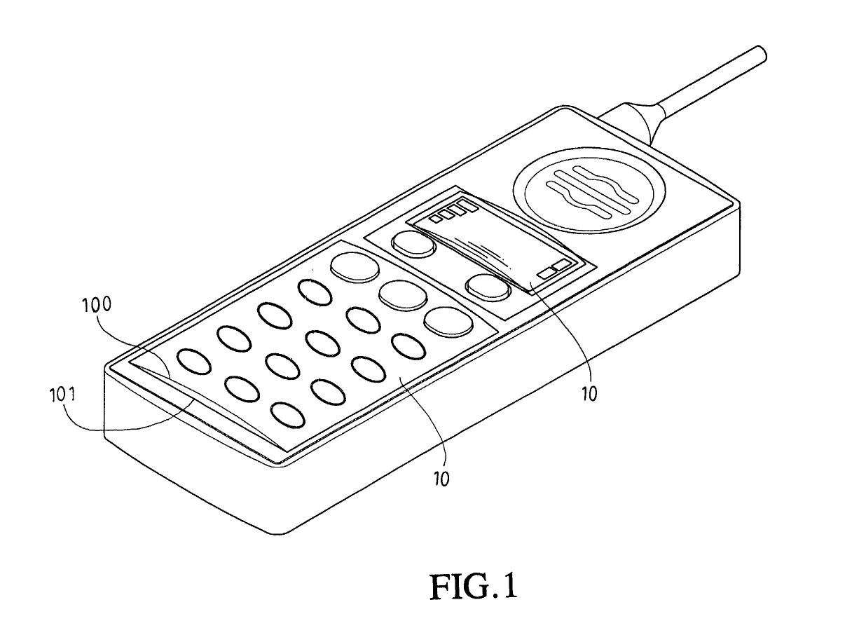

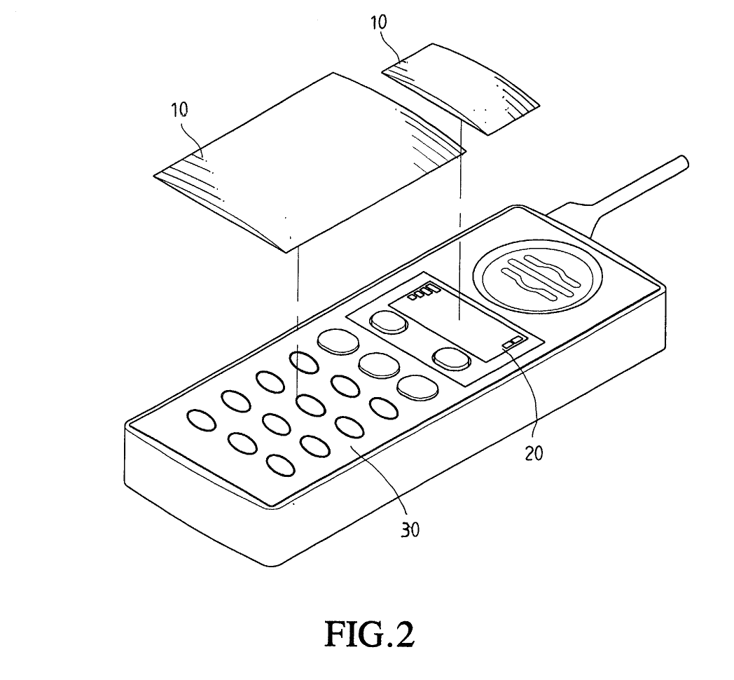

Referring to FIGS. 1, and 2, an optical means for electronic products of the present invention is transparent plate 10 which has a convex surface 100 on a side of the transparent plate 10 and a flat surface 101 on the other side of the transparent plate 10. The flat side 101 of the transparent plate 10 is adhered to an electronic product such as a cellular phone as shown in FIG. 1 wherein two transparent plates 10 are respectively adhered to the screen area 20 and the number pads area 30 of the cellular phone. By this way, the words and/or patterns in the screen and the numbers on the numbers pads of the cellular phone are magnified.

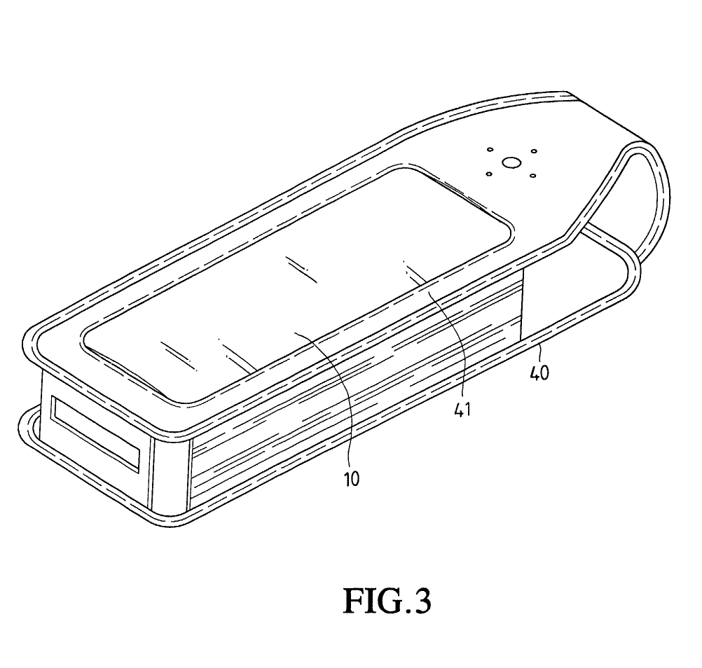

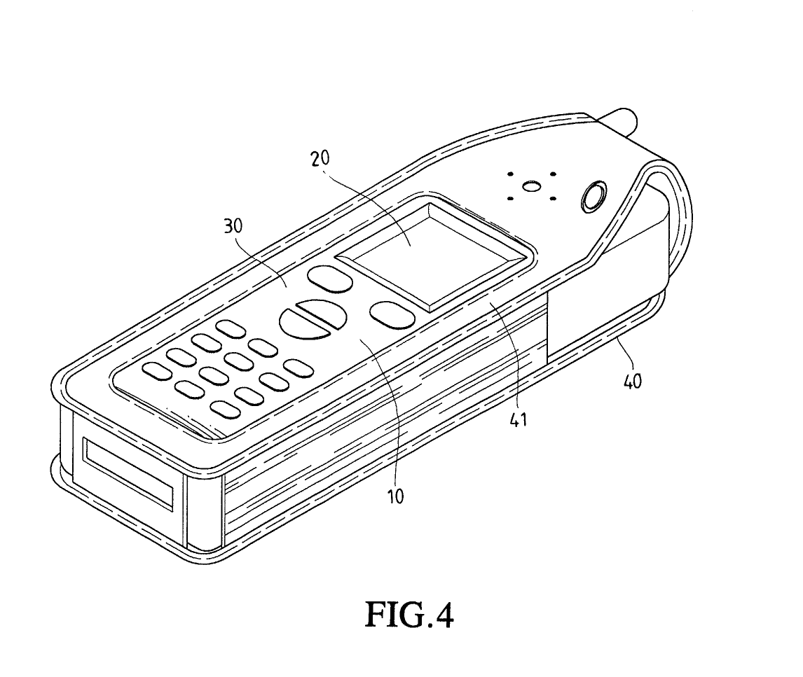

FIGS. 3 and 4 show a cellular phone casing 40 for receiving a cellular phone therein. The casing 40 has an aperture 41 and the transparent plate 10 is adhered to the casing 40 and encloses the aperture 41. When the cellular phone is received in the casing 40, the screen area 20 and the number pads area 30 of the cellular phone are covered by the transparent plate 10.

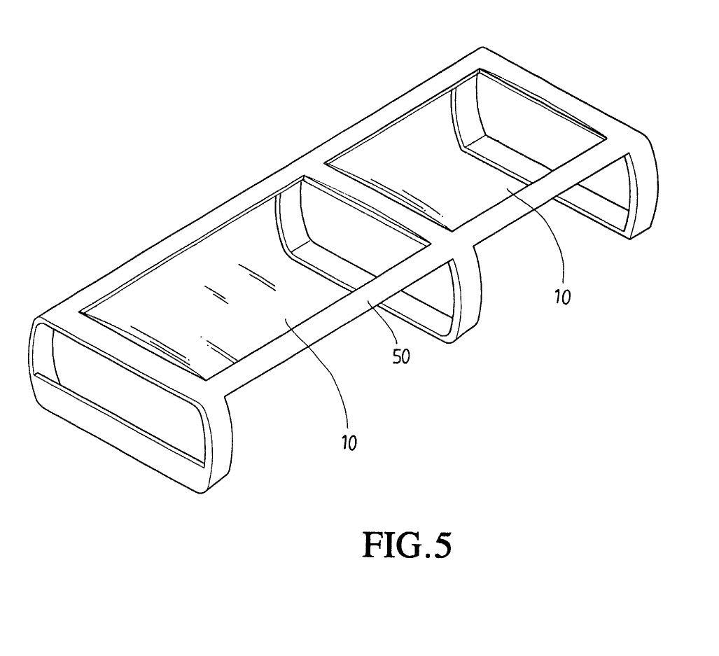

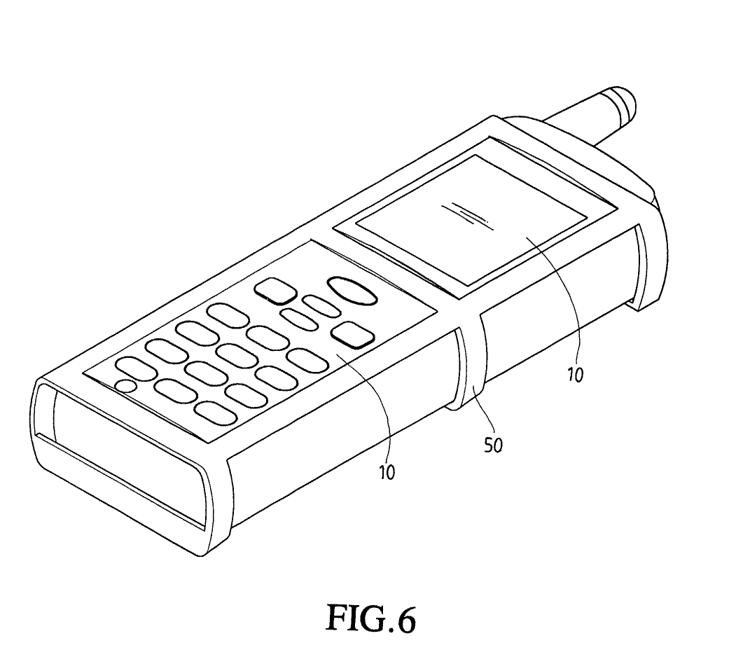

As shown in FIGS. 5 and 6, another type of the cellular phone casing 50 for receiving a cellular phone is illustrated. The casing 50 can be made of soft material such as leather or hard material such as plastic. The casing 50 has two apertures and two transparent plates 10 are respectively adhered to the casing 50 and enclose the two apertures. When the cellular phone is received in the casing 50, the screen area and the number pads area of the cellular phone are magnified by the two transparent plates 10.

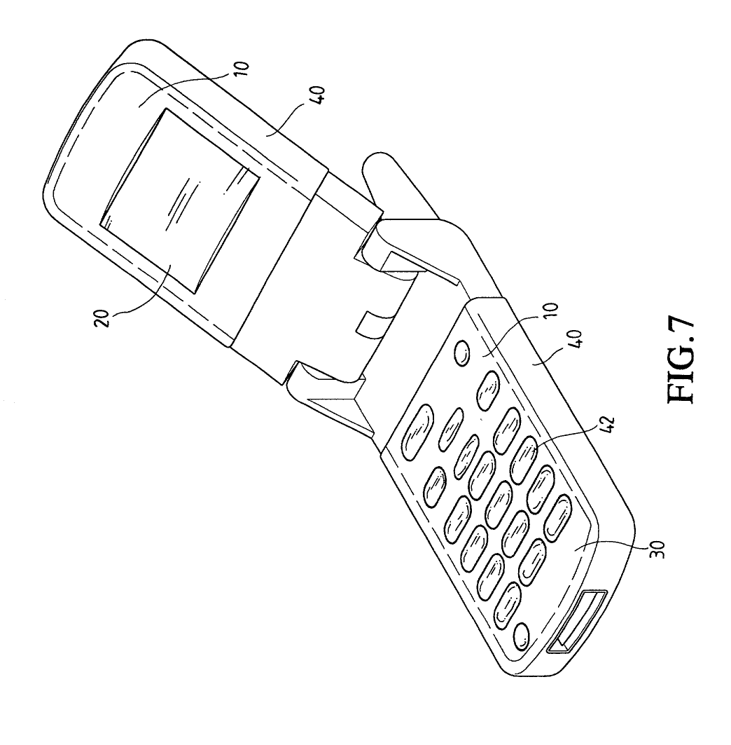

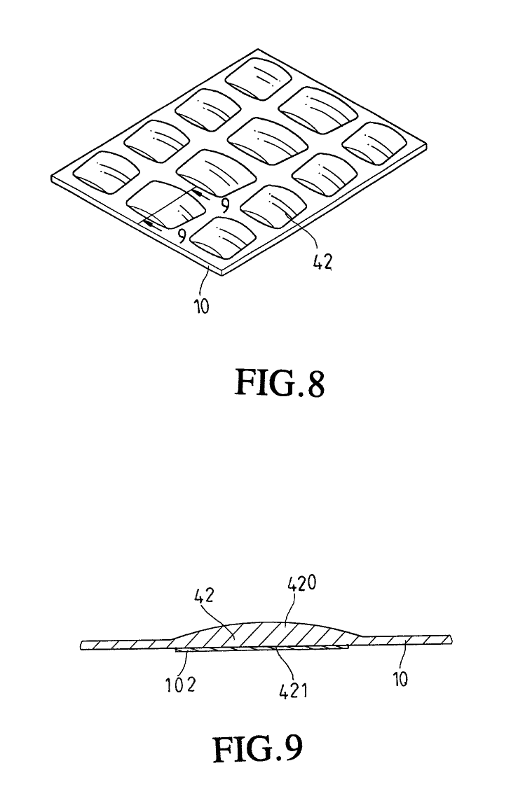

FIGS. 7 to 9 show that the transparent plate 10 includes a plurality of units 42 and each unit 42 has a convex surface 420 and a flat surface 421. The transparent plate 10 is adhered to a casing 40 mounted to the number pads area 30 of the cellular phone so that each unit 42 is mounted to a number pad. The other transparent plate 10 is adhered to the other casing 40 mounted to the screen area 20 of the cellular phone 40.

It is to be noted that the transparent plate 10 of the present invention can be connected to the casing 40 or 50, or to the cellular phone by way of adhering, ultrasonic welding, heat-fusion or any known methods. A pattern or a number 102 can be printed or adhered to the flat surface of the transparent plate 10 so that the pattern or the number 102 is magnified to meet the users' need.

While we have shown and described various embodiments in accordance with the present invention, it should be clear to those skilled in the art that further embodiments may be made without departing from the scope and spirit of the present invention.

What is claimed is:

1. An optical means for electronic products, comprising:
at least one transparent plate having a convex surface on a side of said at least one transparent plate and a flat surface on the other side of said at least one transparent plate, said flat side of said at least one transparent plate adapted to be adhered to the electronic products.

2. The means as claimed in claim 1 further comprising a pattern located on said flat side of said at least one transparent plate.

3. An optical means for electronic products, comprising:
a casing having at least one apertures defined therethrough and said casing adapted to receive to the electronic products, and
at least one transparent plate having a convex surface on a side of said at least one transparent plate and a flat surface on the other side of said at least one transparent plate, said flat side of said at least one transparent plate adhered to said casing and connected along a periphery of said at least one aperture.

4. The means as claimed in claim 3 further comprising a pattern located on said flat side of said at least one transparent plate.
